(19) United States
(12) Patent Application Publication
(10) Pub. No.: US 2015/0185858 A1
(43) Pub. Date: Jul. 2, 2015

(54) SYSTEM AND METHOD OF PLANE FIELD ACTIVATION FOR A GESTURE-BASED CONTROL SYSTEM

(71) Applicant: Wes A. Nagara, Commerce Township, MI (US)

(72) Inventor: Wes A. Nagara, Commerce Township, MI (US)

(21) Appl. No.: 14/550,540

(22) Filed: Nov. 21, 2014

Related U.S. Application Data
(60) Provisional application No. 61/920,983, filed on Dec. 26, 2013.

(51) Int. Cl. G06F 3/01

(52) U.S. Cl. CPC G06F 3/017

(57) ABSTRACT

A system and method for gesture-based control of an electronic system is provided herein. The system includes a recognition device to recognize a gesture-based input; a space detector to detect a portion of space the gesture-based input populates; and a correlator to correlate the portion of the space and the gesture-based input with a predefined operation associated with the electronic system.

### CROSS-REFERENCE TO RELATED APPLICATIONS

This U.S. patent application claims priority to U.S. Patent Application No. 61/920,983, filed Dec. 26, 2013 entitled “System and Method of Plane Field Activation for a Gesture-Based Control System,” now pending. This patent application contains the entire Detailed Description of U.S. Patent Application No. 61/920,983.

### BACKGROUND

Past and current technologies typically require physical contact with buttons or screens to activate certain functions in both vehicles and other user electronics. However, in an effort to make the use of technology easier for users, manufacturers began researching and developing human to machine interfaces or gesture-based control systems to eliminate physical contact.

Gesture-based control systems allow a user to interact with different features without having to interact with a physical interface, such as a touch screen or a push button. As technology advances, gesture-based control has become a reality and has become increasingly popular over the years in both automotive controls and smart devices, such as computers, tablets, video games, and smart phones.

Currently, gesture-based control systems in both automotive controls and smart devices are limited in use. Typically, these systems utilize a sensor or a camera and a controller to perform certain functions. The sensor or camera may detect gestures in a predetermined region where the sensor or camera is located, such as in front of a vehicle user interface or in front of a steering wheel. Such regions are typically preprogrammed in the vehicle. Further, the sensor or camera also may detect gestures which are predetermined by the manufacturer of the vehicle. In other words, certain gestures such as a wave of a user's hand in a certain direction will correspond to a certain functions, such as turning on or adjusting the air conditioning. Additionally, such gestures may correspond to certain predetermined regions. For example, if the user would like to adjust the temperature in the vehicle, the user performs the predetermined gesture for adjusting the temperature such as a wave of the user's hand in the predetermined region such as in front of the air conditioning unit within the vehicle.

Such gesture-based controls systems have left users little room for adjustment or creativity to define their own gesture and their own region of where the gesture should be performed. Additionally, such systems may not be conducive to certain users who may not be able to perform such gestures or reach such regions based on their physical ability. Moreover, such predetermined gesture or regions may not be intuitive or natural to the user.

### SUMMARY

The aspect of the present disclosure provides a system for plane field activation and a method for activating a plane for gesture based control.

The plane field activation system may include a gesture detection device configured to detect a user's hand and fingers when the user performs a gesture. The gesture recognition device may be located anywhere, such as a vehicle cabin. A translation module may be communicatively connected to the gesture recognition device for receiving a signal from the gesture recognition device indicative of gesture performed. The translation module converts the signal into a readable string of data. The system may also include a correlation module communicatively connected to the translation module which may be configured to correlate the gesture performed to a selected feature and a select point in space within the vehicle. The correlation module may be communicatively connected to the electronic control unit which stores the selected point in space and the corresponding feature and gesture in memory. The electronic control unit may also be configured to control and adjust features within the vehicle. Additionally, the system may include a user interface which may be utilized to select the point in space, the feature, and the gesture desired.

The method for defining a point in space in a vehicle for a gesture-based control includes activating a plane field activation mode via a user interface. After the plane field activation mode is activated, a point in space to activate a feature may be selected using a gesture recognition device. The method also includes selecting a feature corresponding to the selected point in space via the user interface. A gesture may be selected to correspond to the selected point in space and the selected feature also employing the user interface.

The aspects disclosed herein provide various advantages. For instance, the user may define the region in which they may perform a gesture to control a specific feature of the vehicle. The user may define gestures for controlling the specific feature. Both may allow the user to be more comfortable. Further the aspects disclosed herein may be more intuitive for the user to perform the gesture for controlling a specific feature of the vehicle. Moreover, the user no longer has to have physical contact with a feature to control the interface.

### BRIEF DESCRIPTION OF THE DRAWINGS

Other advantages of the present disclosure will be readily appreciated, as the same becomes better understood by reference to the following detailed description when considered in connection with the accompanying drawings wherein:

FIG. 1 is a block diagram of the plane field activation system in accordance with the present disclosure; and

FIG. 2 is an illustration of the plane field activation system in accordance with the present disclosure;

FIG. 3 is another illustration of the plane field activation system in accordance with the present disclosure;

FIG. 4 is another illustration of the plane field activation system in accordance with the present disclosure;

FIG. 5 is another illustration of the plane field activation system in accordance with the present disclosure;

FIG. 6 is another illustration of the plane field activation system in accordance with the present disclosure;

FIG. 7 is a flowchart of the method for selecting a plane for gesture based control in accordance with the present disclosure.

### DETAILED DESCRIPTION

Detailed examples of the present disclosure are provided herein; however, it is to be understood that the disclosed examples are merely exemplary and may be embodied in various and alternative forms. It is not intended that these examples illustrate and describe all possible forms of the disclosure. Rather, the words used in the specification are words of description rather than limitation, and it is understood that various changes may be made without departing from the spirit and scope of the disclosure.

The aspects disclosed herein provide a plane field activation system and a method for selecting a point in space for a gesture-based control system within a vehicle cabin.

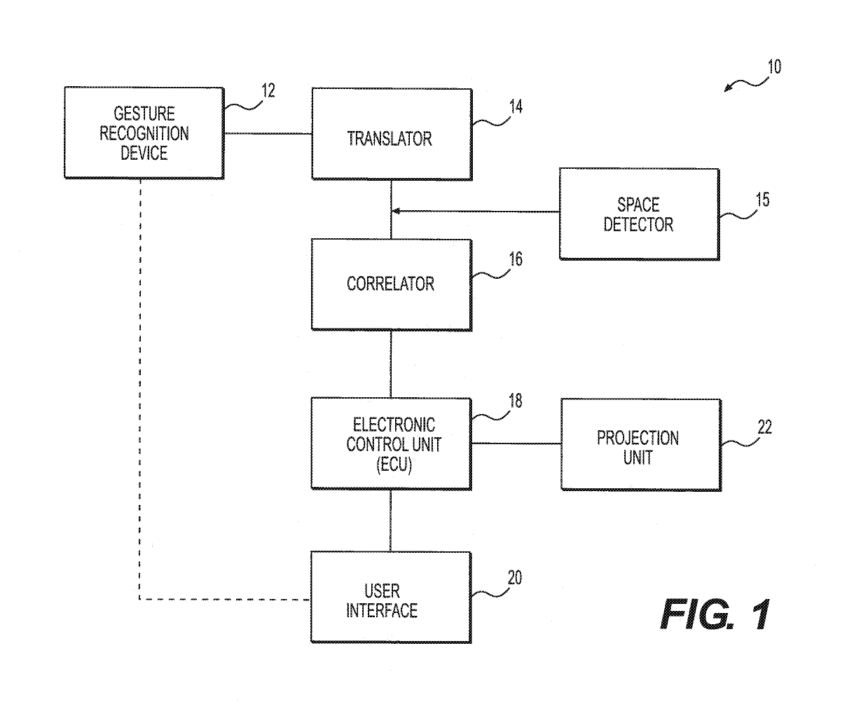

With respect to FIG. 1, a block diagram of the plane field activation system 10 in accordance with the present disclosure is provided. The plane field activation system 10 may have a gesture recognition device 12. The gesture recognition device 12 may be, but is not limited to, a sensor. The sensor may be configured to detect a user's hand and fingers. The sensor may be an infrared sensor. The gesture recognition device 12 may be located within the front region of the vehicle cabin to detect gestures of the driver and passengers.

For example, the gesture recognition device 12 or sensor may be located within a vehicle control panel, a user interface, or a vehicle dashboard. Additionally, the gesture recognition device 12 may include a plurality of sensors located throughout the vehicle cabin to also detect gestures of passengers located within the back region of the cabin. For instance, the gesture recognition device 12 may be located within an air conditioning unit in the back region of the vehicle for use of the passengers seated in the back seat.

The gesture recognition device 12 could also be located with a panel within the roof inside the vehicle cabin. Alternatively, the gesture recognition device 12 may be a camera or a plurality of cameras located through the vehicle cabin to detect gestures of the driver and passengers.

A translator 14 may be communicatively connected to the gesture recognition device 12. The translator 14 may be configured to receive a signal indicative of a specific gesture the user is performing. Additionally, the translator 14 may be configured to translate or convert the signal received from the gesture recognition device 12 into a readable string of data or command. The translator 14 may utilize a look up table to convert the signal into data based on the gesture detected by the gesture recognition device 12. The look up table may be preprogrammed by the manufacturer, developer, or may be programmed by the user when activating a plane field activation mode and selecting a gesture to correspond to a specific point in space or zone of the vehicle.

A space detector 15 is also provided to detect a point in space associated with the recognized gesture. The gesture recognition device 12 may be configured to recognize a predefined space in front of a camera or image capturing device.

The plane field activation system 10 may also include a correlator 16. The correlator 16 may be communicatively connected to the translator 14 and the space detector 15. The correlator 16 may be configured to receive a second signal indicative of the gesture performed by the user generated by the translator 14 and the point in space detected by the space detector 15. The correlator 16 may also be configured to correlate the point in space selected to control a feature within the vehicle, the feature selected to be controlled, and the gesture used to control the feature within the vehicle. The correlator 16 may utilize a look up table to associate the point in space selected and the gesture used. The look up table may be preprogrammed by the manufacturer or developer. Alternatively, the look up table may be programmed by the user of the vehicle when activating the plane field activation mode and selecting the point in space and gesture associated with the point in space. The correlator 16 may otherwise, store the data or information related to the point in space selected and corresponding gesture.

An electronic control unit (ECU) 18 may be communicatively connected to the correlator 16. The ECU 18 may have any combination of memory storage such as random-access memory (RAM) or read-only memory (ROM), processing resources or a microcontroller or central processing unit (CPU) or hardware or software control logic to enable management of the ECU 18. Additionally, the ECU 18 may include one or more wireless, wired or any combination thereof of communications ports to communicate with external resources as well as various input and output (I/O) devices, such as a keyboard, a mouse, pointers, touch controllers, and display devices. The ECU 18 may also include one or more buses operable to transmit communication of management information between the various hardware components, and can communicate using wire-line communication data buses, wireless network communication, or any combination thereof. The ECU 18 may be configured to store the point in space selected in memory. Additionally, the ECU 18 may be configured to store the corresponding or associated gesture and feature selected to be controlled by the gesture in memory. The ECU 18 may control the feature within the feature as well.

The plane field activation system 10 may also have a user interface 20. The user interface 20 may be the module of the system 10 in which the user interacts with. The user interface 20 may include a first display such as a liquid crystal display, a capacitive touch screen, or a resistive touch screen and a second display 26 such as a smart button. The user interface 20 may further include the gesture recognition device 12 or a second gesture recognition device which may be used to activate the plane field activation mode. Additionally, the user interface 20 may have a microphone which may be used during voice recognition or for telephone use.

The user interface 20 may be used to activate the plane field activation mode to define a point in space within the vehicle for gesture-based control of a feature. The plane field activation mode may be activated by a push button, touch screen, voice command, or a gesture preprogrammed into the vehicle or programmed by the user to activate the plane field activation mode. For example, a user within the vehicle may press a push button within the user interface which activates the plane field activation mode and the user may then select a point in space in which they desire to control a feature.

Once the plane field activation mode is activated, the point in space may be selected via the user interface 20. The point in space may include an xyz point, a two-dimensional plane, a three-dimensional object, or another space or region within the vehicle to perform gestures for controlling different features of the vehicle. The user interface 20 may also be used to select the feature and the gesture to correspond to the point in space. For instance, the user or developer may select the point in space in front of the air conditioning unit for controlling the temperature within the vehicle. The user may select the point in space by one or more inputs such as selecting a predetermined zone or actually setting the bounds of the point in space via push buttons, touch screen, voice command, or by physically gesturing the location of the zone.

Additionally, the user interface 20 may display an image of the selected point in space on the first display to indicate to the user the bounds of that point in space. The image on the first display may change based on where the user's hand is within the vehicle cabin. For instance, the interface may display a three-dimensional box in front of the steering wheel in which the user may control the volume of the stereo system by waving their hand up and down. When the user moves their hand outside of that box, an image on the display may change back to a menu setting or may show the plane in which the user's hand is now located in. The second display may also be used to indicate the bounds of the point in space. For example, the second display may illuminate when the user's hand is within the bounds of the point in space. Alternatively, the user interface 20 may produce audible feedback to indicate to the user the bounds of the selected point in space.

The plane field activation system 10 may also include in a projection unit 22. The projection unit 22 may be communicatively connected to the ECU 18 and may be configured to project a hologram or a three-dimensional virtual object of the point in space to the user. The hologram or virtual object may change depending on where the user's hand is located within the vehicle cabin. For instance, the projection unit 22 may display a three-dimensional box in the point in space 28, such as in front of the steering wheel which the user may have selected within the vehicle. The user will then be able to visual the point in space 28 and may move their hand in and out of the box.

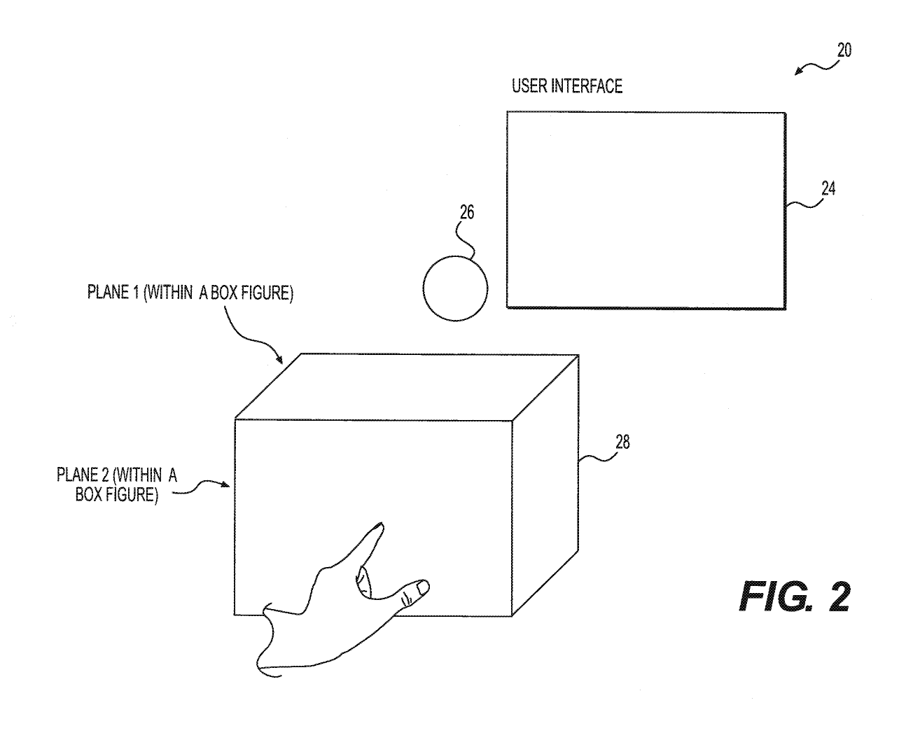

With respect to FIGS. 2 to 6, several illustrations of the plane field activation system 10 in accordance with the present disclosure are shown. Specifically, each figure shows a user interface 20 and various selected points in space. As discussed above, the user interface 20 may include a first display 24 and a second display 26. The first display 24 may be a liquid crystal display, a capacitive touch screen, or a resistive touch screen. The first display 24 may be configured to display the point in space 28 selected. The second display 26 may be a smart button which may have various functions. The smart button may be a touch screen or a push button. The smart button may be configured to set the point in space 28, the selected feature, and the gesture. Additionally, the smart button may indicate to the user the bounds of the point in space 28. For example, the smart button may illuminate when the user's hand is within the point in space 28 selected or the smart button may illuminate when the user's hand goes outside of the point in space 28 selected to indicate to the user that their hand is within or outside of the point in space 28.

FIGS. 2 to 6 also provide the point in space 28 that is selected for gesture based control as well as multiple points in space. FIG. 2 shows multiple planes forming a three-dimensional box as the selected point in space 28 for gesture-based controls. In particular, six planes form the three-dimensional box (three planes not shown). As shown by the arrows, there may be a first plane in which the user may gesture in. Additionally, there may be a second plane in which the user may gesture in. The individual planes may be the point in space 28 described above.

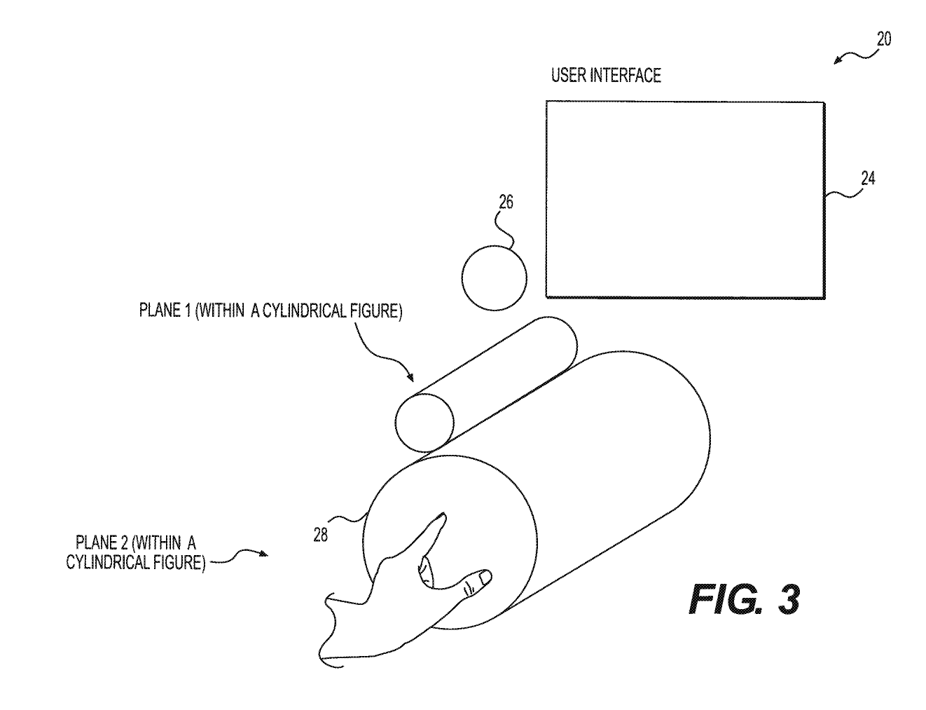

Alternatively, the six planes together may form the point in space 28, as described above. For instance, the box shown in FIG. 2 may have been selected to control the fan speed within the vehicle. When the user hand is within the box, the user may control the fan speed. When the user's hand is outside of the box, the user may not control the fan speed using gestures. Such point in space 28 is not limited to a three dimensional box. Instead, the point in shape may have a cylindrical shape disposed between two planes, as shown in FIG. 3. Similarly, as discussed previously, when the user's hand is within the cylinder, the user may control the desired feature.

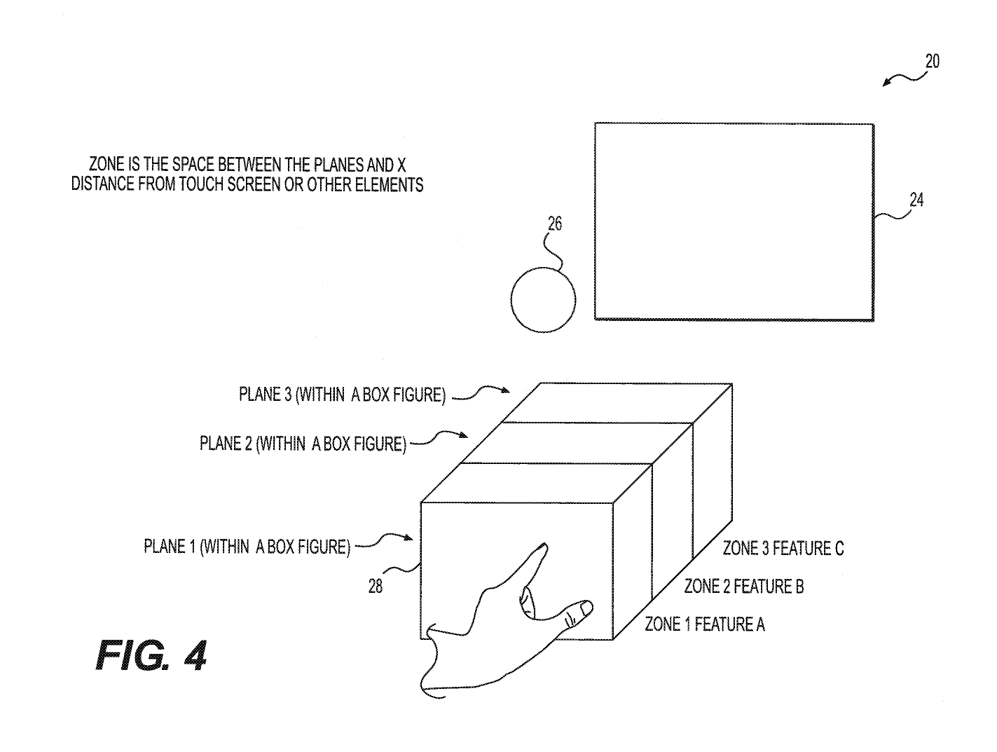

Additionally, there may be multiple two dimensional planes or three-dimensional figures which are each configured to represent a different feature as shown in FIG. 4. There may be a first zone or point in space 28 which controls feature ‘A’, a second zone or point in space 28 which controls feature ‘B’, and a third zone or point in space 28 which controls feature ‘C’. Another zone may be the space between the planes and X distance from the touch screen or other elements. For instance, the three-dimensional box for the first zone may control temperature within the vehicle. The three-dimensional box for the second zone may control the radio and the three-dimensional box for the third zone may control the telephone within the vehicle. When the user moves their hand through each zone, the user will have the ability to control the feature corresponding to that zone.

Moreover, as discussed previously, the second display 26 or smart button within the user interface 20 may change color when the user's hand passes through each zone to indicate which zone the user is in. For example, if the first zone corresponds to the color red, when the user's hand passes through the first zone the second display 26 may illuminate red. In addition, if the second zone corresponds to the color blue, when the user's hand passes from the first zone to the second zone the second display 26 may illuminate blue.

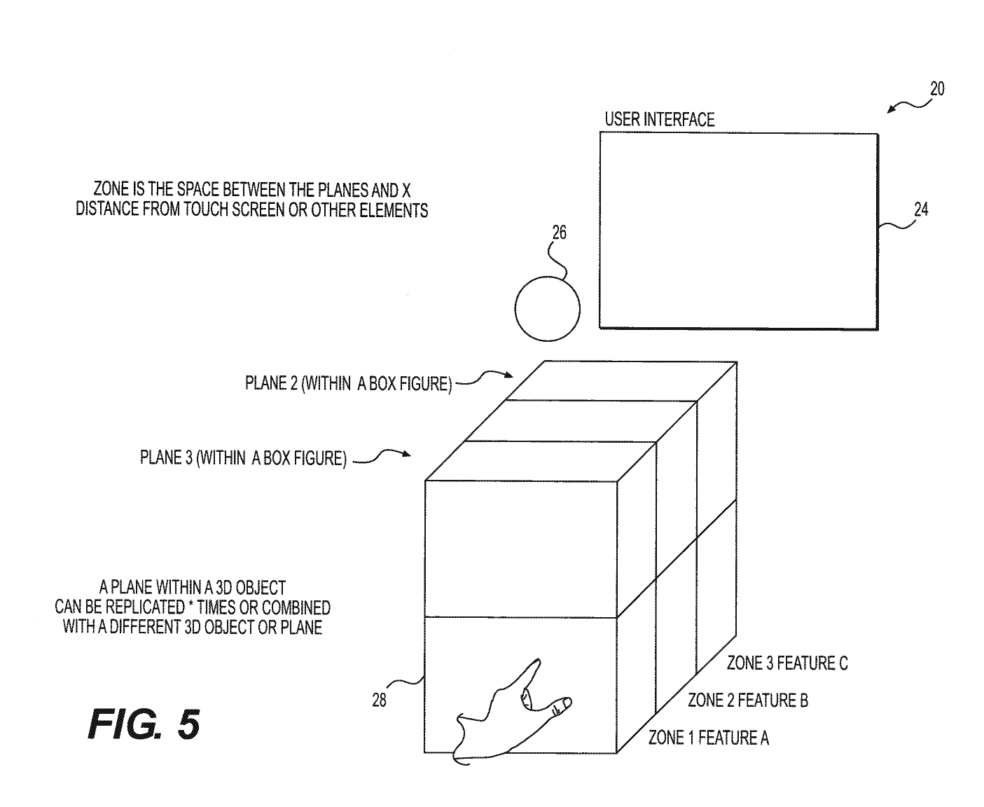

FIG. 5 is another example of a plurality of three-dimensional points in space or zones within the vehicle cabin. Each zone may be configured to control a different feature. For example, the first three-dimensional point in space may be configured to control the temperature within the vehicle, the second three-dimensional point in space may be configured to control the fan speed within the vehicle, and the third three-dimensional point in space may be configured to control the volume of the stereo system within the vehicle. Specifically, the plane within the three-dimensional object can be replicated x number of times or combined with a different three-dimensional object or plane. Moreover, the plurality of three-dimensional zones may be stacked or located adjacent to one another. FIG. 5 specifically shows six three-dimensional boxes. However, the plurality of three-dimensional points in space or zones is not limited to three-dimensional boxes or the same shapes.

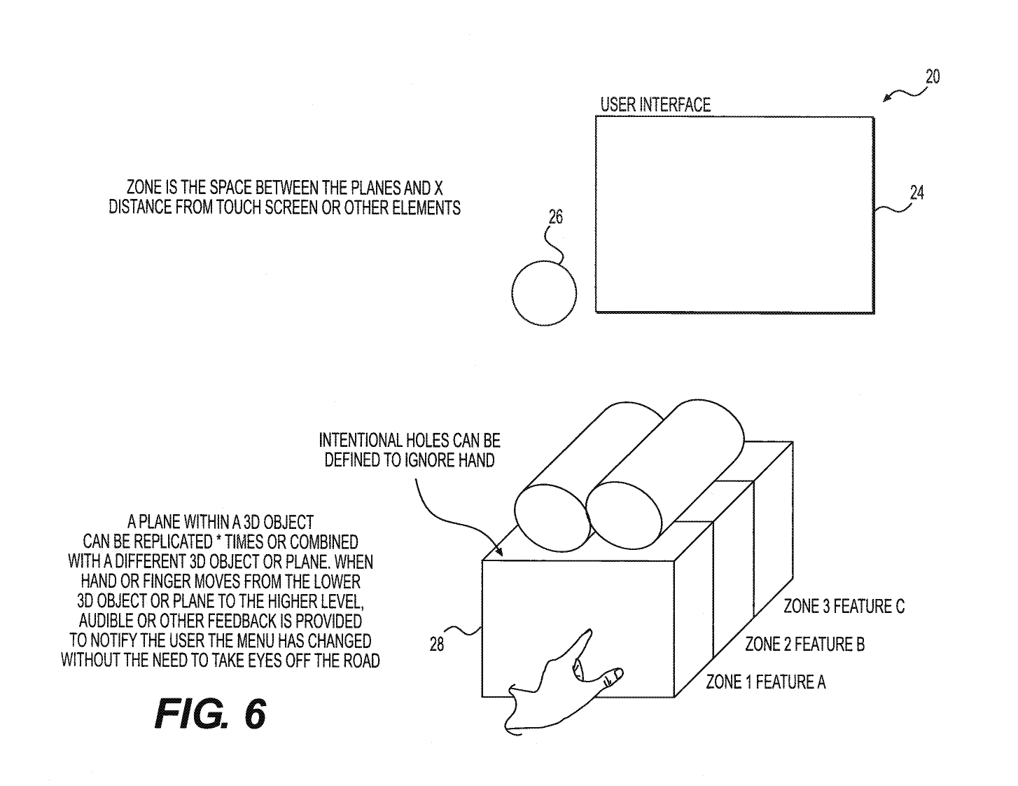

As shown in FIG. 6, there is a plurality of three-dimensional cylinders and three-dimensional boxes which are each are configured to control a different feature. In other words, the plane within a three-dimensional object can be replicated x times or combined with a different three-dimensional objection or plane. In operation, when the user's hand or a finger move from the lower three-dimensional object or plane to the higher level, audible feedback or other feedback such as the second display 26 illuminating a color is provided to notify the user the menu has changed without the need to take eyes off the road. Additionally, just as the point in space 28 or plane may be selected or defined, an intentional hole may be selected or defined to ignore the hand. In other words, a zone or region in the vehicle may be left undefined and would not be configured to control the feature by gestures. For example, the user may intentionally not set the zone by the shifter or the gear stick within the vehicle to control of a feature. Thus, when the user goes to reach for the shifter to change gears, no feature within the vehicle will change or adjust.

Additionally, the plurality of three-dimensional objects may not be limited to placement in the front of the vehicle within the driver and passenger's reach. A single object or plane or a plurality of objects may be selected in the back of the vehicle where other passengers may be seated to control various features within the vehicle. The features may be specific to the back of the vehicle. For instance, the user may be able to select the point in space in the back of the vehicle for adjusting the volume in the back of the vehicle to a different volume than the front of the vehicle. The user in the back of the vehicle may employ the same methods as the front of the vehicle in activating the plane field activation mode.

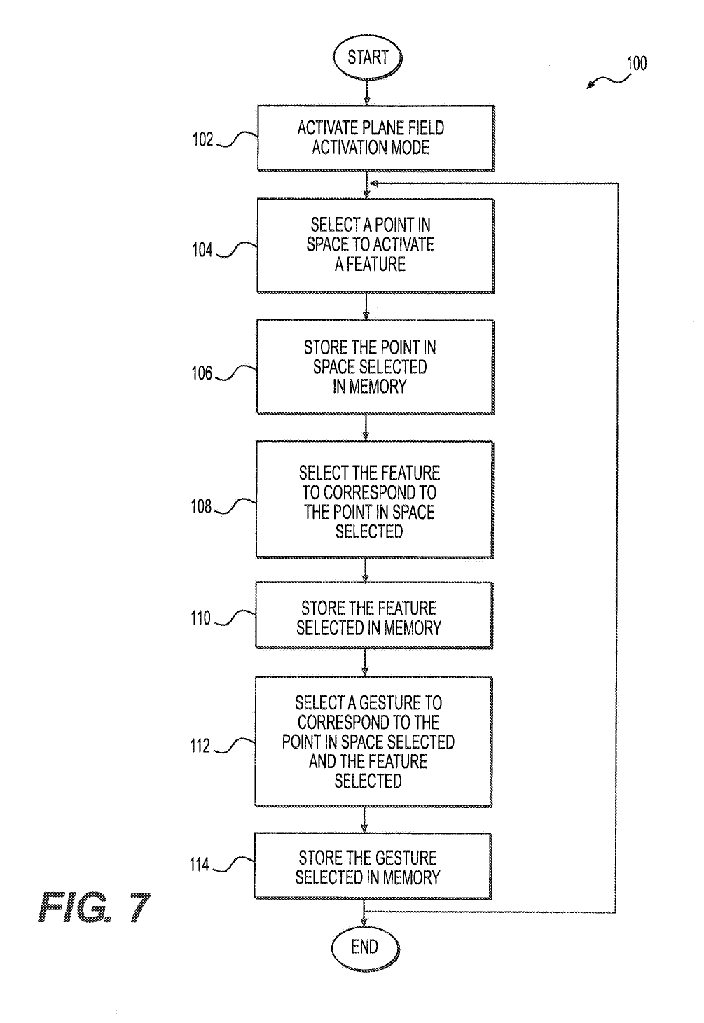

FIG. 7 is a flowchart of a method for selecting a point in space in a vehicle for gesture-based controls 100. The method of FIG. 7 includes activating a plane field activation mode within the vehicle via a user interface 102. The user interface may be similar to the user interface discussed in FIGS. 1 to 6. Triggering the plane field activation mode allows the vehicle to recognize that the user desires to program or set their own point of space, plane, or space to perform gestures for controlling different features within the vehicle.

The user interface may have a single input or a variety of inputs which may each individually trigger the plane field activation mode. For instance, the plane field activation mode may be activated by a push button within the user interface. The plane field activation mode may be activated by a touch screen within the user interface. The touch screen may be, but is not limited to, a liquid crystal display, a capacitive touch screen, or a resistive touch screen. Alternatively, the plane field activation mode may be activated by voice command via the user interface. As described above, the user interface may have a microphone for receiving a user voice commands. The microphone may have other purposes as well. Additionally, the plane field activation mode may be activated by a gesture programmed by the user. The gesture may be programmed by the user or may be preprogrammed in the vehicle.

The method further includes selecting a point in space to activate a feature using the gesture recognition device 104. The point in space may be a zone in the vehicle cabin. The zones may be predetermined by the manufacturer. Alternatively, the regions may be programmed by the user. The point in space may a two-dimensional plane. Also, the point in space may be a three-dimensional shape or object. The feature may be any feature within the vehicle such as, but not limited to, air conditioning, GPS, radio, telephone, and menus displayed on the user interface regarding any feature. With respect to the gesture recognition device, the gesture recognition device may be a sensor configured to detect the user's hand and to interpret the gesture of the user hand. The gesture recognition device may be located within the user interface. The gesture recognition device may otherwise be located anywhere within the vehicle cabin. In addition, the gesture recognition device may be a plurality of sensors or a network of sensors, which may interact with one another. The gesture recognition device may otherwise be a camera, a plurality of cameras, or a network of cameras.

After the point in space is selected, the point in space may be displayed to the user. The point in space may be displayed on the screen within the user interface. On the other hand, the point in space may be displayed as a hologram or three-dimensional projection generated via a projection unit. The displayed point in space indicates to the user the bounds of the point in space. Based on the displayed point in space, the user may adjust (i.e. expand or reduce) the bounds of the point in space. The user may adjust the bounds by the methods described above for selecting the point in space.

The method further includes storing the selected point in space in memory of the electronic control unit (ECU). After the storing the selected point in space in memory, the feature may be selected to correspond to the point in space selected. The feature may be selected via the user interface. Similar as discussed above, in regards to the method of selecting the point in space, the feature may be selected by push button, touch screen, voice command or a gesture programmed in the vehicle. The gesture may be preprogrammed by the user or may be preset the manufacturer. The selected feature corresponding to the selected point in space may be stored in the memory of the ECU.

The method further includes selecting a gesture to correspond to the selected point in space and the selected feature in memory of the ECU. The gesture may be preset in the vehicle by the manufacturer or the gesture may be programmed to be any gesture desired by the user. The user may then test the point in space with the corresponding feature and gesture to determine that the point in space is defined to per their request. In addition, a second point in space or as many points in space as the user desires may be selected via the interface for a second feature and a second gesture, as described above with respect to FIGS. 1 through 6.

Additionally, the system and method is not limited to only selecting a specific point in space once to control a specific feature using a specific gesture. Instead, the system and method allows for each to be changed at any time. For example, the user may have selected a three-dimensional box in front of the air conditioning unit to control the temperature within the vehicle by moving their hand from left to right. The user may reselect that same three-dimensional box in front of the air conditioning unit and change the feature to control the fan speed and change the gesture to have their hand from up and down using the user interface.

While examples of the disclosure have been illustrated and described, it is not intended that these examples illustrate and describe all possible forms of the disclosure. Rather, the words used in the specification are words of description rather than limitation, and it is understand that various changes may be made without departing from the spirit and scope of the disclosure. Additionally, the features and various implementing embodiments may be combined to form further examples of the disclosure.

We claim:

1. A system for gesture-based control of an electronic system, comprising:
a recognition device to recognize a gesture-based input;
a space detector to detect a portion of space the gesture-based input populates; and
a correlator to correlate the portion of the space and the gesture-based input with a predefined operation associated with the electronic system.

2. The system according to claim 1, wherein the recognition device is configured to monitor the space, and the portion of the space is a smaller subset of the space.

3. The system according to claim 2, wherein the space detector detects a second portion of the space, and the correlator correlates the second portion of the space and the gesture-based input with a second predefined operation.

4. The system according to claim 2, wherein the space detector is configured to detect a third portion of space the gesture-based input populates, the third portion of space being an intentional hole; and the correlator is configured to ignore the detected gesture-based input in response to being detected in the third portion.

5. The system according to claim 3, wherein the portion is defined by a first shaped polygon, and the second portion is defined by a second shaped polygon, and the shaped polygon and the second shaped polygon differ from each other.

6. The system according to claim 3, further comprising an activation button configured to be engaged to enable/disable the space detection.

7. The system according to claim 3, wherein in response to a detection of a change from the portion to the second portion, the electronic system is configured to indicate a notification.

8. The system according to claim 7, wherein the notification is an audible sound.

9. The system according to claim 1, wherein the portion of space is configurable by a user of the electronic system.

10. The system according to claim 1, wherein the predefined function is configurable by a user of the electronic system.

11. A method for gesture-based control of an electronic system, comprising:
selecting a portion in space to be defined for activating a feature; and
selecting a feature associated with the electronic system to correspond to the selected portion in space,
wherein the portion of space is configured to correspond to a detection of a gesture-based input associated with the gesture-based control.

12. The method according to claim 11, wherein a second portion in space is defined adjacent to the portion in space, the portion and the second portion being smaller than an overall area detectable by the gesture-based control.

13. The method according to claim 11, wherein a third portion in space is defined adjacent to the portion in space, the third portion in space configured to not control any feature associated with the electronic system.
